(19) United States
(12) Patent Application Publication
(10) Pub. No.: US 2026/0300104 A1
(43) Pub. Date: Oct. 1, 2026

(54) PREVIEW FOR MERGE OPERATION IN RECOVERY

(71) Applicant: Rubrik, Inc., Palo Alto, CA (US)

(72) Inventors: Sai Swarup MOHANTY, Bangalore (IN); Manoj KUMAR D V, Bangalore (IN); Sandeep KANYAL, Bangalore (IN)

(21) Appl. No.: 19/092,588

(22) Filed: Mar. 27, 2025

(51) Int. Cl. G06F 11/14; G06F 11/32

(52) U.S. Cl. CPC G06F 11/1464; G06F 11/1469; G06F 11/328

(57) ABSTRACT

Methods, systems, and devices for data management are described. A data management system (DMS) may receive a request to recover attributes associated with directory objects within a directory of a client system to a version of the attributes as of a first time at which a prior backup of the attributes was obtained. The DMS may output, via a user interface, a representation of a merged state of the attributes based on a merge operation. The merged state may be based on a merge between a first state of the attributes at the first time and a live state of the attributes as of a second time at which the merge is performed. The DMS may receive, via the user interface, a request to recover the attributes using the merged state or to maintain the live state of the attributes based on the representation of the merged state.

### FIELD OF TECHNOLOGY

The present disclosure relates generally to data management, including techniques for preview for merge operation in recovery.

### BACKGROUND

A data management system (DMS) may be employed to manage data associated with one or more computing systems. The data may be generated, stored, or otherwise used by the one or more computing systems, examples of which may include servers, databases, virtual machines, cloud computing systems, file systems (e.g., network-attached storage (NAS) systems), or other data storage or processing systems. The DMS may provide data backup, data recovery, data classification, or other types of data management services for data of the one or more computing systems. Improved data management may offer improved performance with respect to reliability, speed, efficiency, scalability, security, or ease-of-use, among other possible aspects of performance.

### BRIEF DESCRIPTION OF THE DRAWINGS

FIG. 1 illustrates an example of a computing environment that supports preview for merge operation in recovery in accordance with aspects of the present disclosure.

FIG. 2 shows an example of a merge preview configuration that supports preview for merge operation in recovery in accordance with aspects of the present disclosure.

FIG. 3 shows an example of a process flow that supports preview for merge operation in recovery in accordance with aspects of the present disclosure.

FIG. 4 shows a block diagram of an apparatus that supports preview for merge operation in recovery in accordance with aspects of the present disclosure.

FIG. 5 shows a block diagram of a merge recovery component that supports preview for merge operation in recovery in accordance with aspects of the present disclosure.

FIG. 6 shows a diagram of a system including a device that supports preview for merge operation in recovery in accordance with aspects of the present disclosure.

FIGS. 7 through 9 show flowcharts illustrating methods that support preview for merge operation in recovery in accordance with aspects of the present disclosure.

### DETAILED DESCRIPTION

A data management system (DMS) may obtain backups of an active directory of a client's system at different times during operation and may store the backups in memory. The active directory may be a central database for managing and organizing various directory objects within the client system, where a directory object may be, for example, a data object corresponding to (e.g., representative of) a user, group, tenant, or other type of directory entry or directory member. The client may request to restore or otherwise recover their system directory to a certain state by selecting a previous backup, and the DMS may facilitate restoration of the client's directory to the state corresponding to the time associated with the selected backup. However, as performed by some DMSs, the restoration of the client's directory may be performed by overwriting existing (e.g., live) attributes that define various properties of one or more directory objects in the client's directory and may not preserve or otherwise account for changes (e.g., additions or deletions) made after the time of the backup corresponding to the requested recovery state, which may be referred to as a recovery state, recovery point, or recovery time. Accordingly, such recovery operations may be incomplete or error-prone.

Techniques described herein provide for a DMS to perform a merge operation in response to a recovery request and to output an initial preview (e.g., a mock recovery) of a result of the merge operation for the user to review. The user may decide whether to perform the actual recovery or to correct one or more errors in the system (e.g., within the directory or elsewhere in the client's system) before performing the recovery based on the preview. The merge operation may account for (e.g., preserve) changes in data, directory objects, and corresponding attributes that occurred after the requested recovery time. For example, the DMS may merge backup values from the requested backup with live values of the data in the live (current) version of the client's system. Values that were deleted from the user's system after the requested recovery time may not be available for inclusion in the merge, but other values that were added to or otherwise modified in the user's system after generation of the backup corresponding to the requested recovery time may be available for inclusion in the merge.

The DMS may display, via a user interface, a result of the merge. The user may review the displayed results and decide whether to request the DMS to perform the recovery and overwrite a live state of at least one or more attributes for one or more directory objects in the user's directory with the displayed results or whether to perform one or more other operations to avoid potential errors and/or preserve more recently updated or added values before enabling the recovery. For example, if one or more data values (e.g., values of attributes) were in the backup at the requested recovery time and were subsequently deleted from the user's system, the merge results may not include those data values, and the customer may determine whether to overwrite the live state with the merge results (which would exclude those values) or to delay the recovery while separately recovering the one or more data values back to the system before performing another merge and overwriting the live states, among other examples that may improve the reliability and accuracy of data recovery. In some examples, the DMS may perform the merge for linked attribute values, which may be attributes that link to or otherwise point to (e.g., depend on, map to) attribute values within other directory objects.

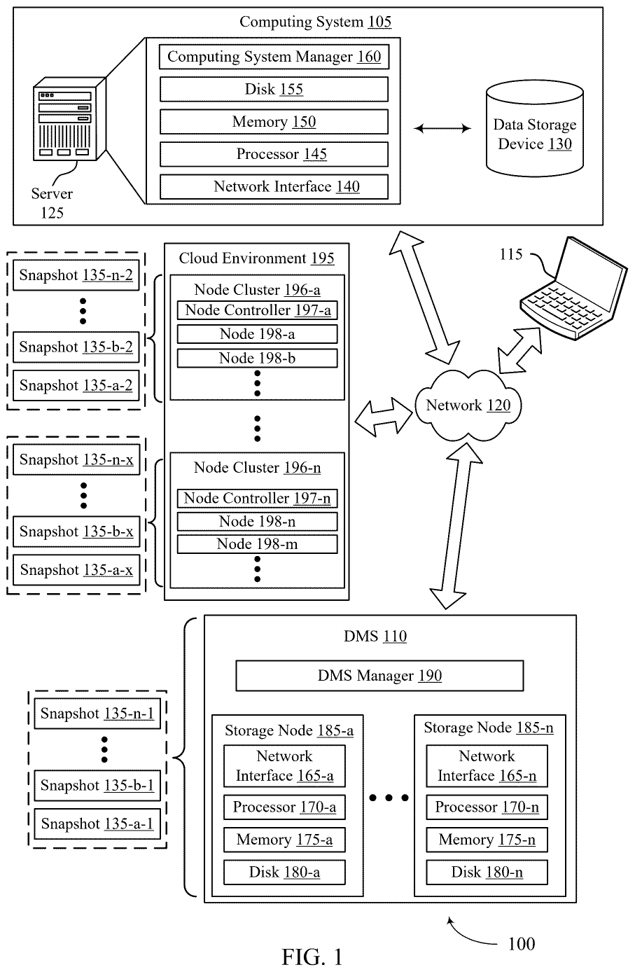

FIG. 1 illustrates an example of a computing environment 100 that supports preview for merge operation in recovery in accordance with aspects of the present disclosure. The computing environment 100 may include a computing system 105, a data management system (DMS) 110, and one or more computing devices 115, which may be in communication with one another via a network 120. The computing system 105 may generate, store, process, modify, or otherwise use associated data, and the DMS 110 may provide one or more data management services for the computing system 105. For example, the DMS 110 may provide a data backup service, a data recovery service, a data classification service, a data transfer or replication service, one or more other data management services, or any combination thereof for data associated with the computing system 105.

The network 120 may allow the one or more computing devices 115, the computing system 105, and the DMS 110 to communicate (e.g., exchange information) with one another. The network 120 may include aspects of one or more wired networks (e.g., the Internet), one or more wireless networks (e.g., cellular networks), or any combination thereof. The network 120 may include aspects of one or more public networks or private networks, as well as secured or unsecured networks, or any combination thereof. The network 120 also may include any quantity of communications links and any quantity of hubs, bridges, routers, switches, ports or other physical or logical network components.

A computing device 115 may be used to input information to or receive information from the computing system 105, the DMS 110, or both. For example, a user of the computing device 115 may provide user inputs via the computing device 115, which may result in commands, data, or any combination thereof being communicated via the network 120 to the computing system 105, the DMS 110, or both. Additionally, or alternatively, a computing device 115 may output (e.g., display) data or other information received from the computing system 105, the DMS 110, or both. A user of a computing device 115 may, for example, use the computing device 115 to interact with one or more user interfaces (e.g., graphical user interfaces (GUIs)) to operate or otherwise interact with the computing system 105, the DMS 110, or both. Though one computing device 115 is shown in FIG. 1, it is to be understood that the computing environment 100 may include any quantity of computing devices 115.

A computing device 115 may be a stationary device (e.g., a desktop computer or access point) or a mobile device (e.g., a laptop computer, tablet computer, or cellular phone). In some examples, a computing device 115 may be a commercial computing device, such as a server or collection of servers. And in some examples, a computing device 115 may be a virtual device (e.g., a virtual machine). Though shown as a separate device in the example computing environment of FIG. 1, it is to be understood that in some cases a computing device 115 may be included in (e.g., may be a component of) the computing system 105 or the DMS 110.

The computing system 105 may include one or more servers 125 and may provide (e.g., to the one or more computing devices 115) local or remote access to applications, databases, or files stored within the computing system 105. The computing system 105 may further include one or more data storage devices 130. Though one server 125 and one data storage device 130 are shown in FIG. 1, it is to be understood that the computing system 105 may include any quantity of servers 125 and any quantity of data storage devices 130, which may be in communication with one another and collectively perform one or more functions ascribed herein to the server 125 and data storage device 130.

A data storage device 130 may include one or more hardware storage devices operable to store data, such as one or more hard disk drives (HDDs), magnetic tape drives, solid-state drives (SSDs), storage area network (SAN) storage devices, or network-attached storage (NAS) devices. In some cases, a data storage device 130 may comprise a tiered data storage infrastructure (or a portion of a tiered data storage infrastructure). A tiered data storage infrastructure may allow for the movement of data across different tiers of the data storage infrastructure between higher-cost, higher-performance storage devices (e.g., SSDs and HDDs) and relatively lower-cost, lower-performance storage devices (e.g., magnetic tape drives). In some examples, a data storage device 130 may be a database (e.g., a relational database), and a server 125 may host (e.g., provide a database management system for) the database.

A server 125 may allow a client (e.g., a computing device 115) to download information or files (e.g., executable, text, application, audio, image, or video files) from the computing system 105, to upload such information or files to the computing system 105, or to perform a search query related to particular information stored by the computing system 105. In some examples, a server 125 may act as an application server or a file server. In general, a server 125 may refer to one or more hardware devices that act as the host in a client-server relationship or a software process that shares a resource with or performs work for one or more clients.

A server 125 may include a network interface 140, processor 145, memory 150, disk 155, and computing system manager 160. The network interface 140 may enable the server 125 to connect to and exchange information via the network 120 (e.g., using one or more network protocols). The network interface 140 may include one or more wireless network interfaces, one or more wired network interfaces, or any combination thereof. The processor 145 may execute computer-readable instructions stored in the memory 150 in order to cause the server 125 to perform functions ascribed herein to the server 125. The processor 145 may include one or more processing units, such as one or more central processing units (CPUs), one or more graphics processing units (GPUs), or any combination thereof. The memory 150 may comprise one or more types of memory (e.g., random access memory (RAM), static random access memory (SRAM), dynamic random access memory (DRAM), read-only memory (ROM), electrically erasable programmable read-only memory (EEPROM), Flash, etc.). Disk 155 may include one or more HDDs, one or more SSDs, or any combination thereof. Memory 150 and disk 155 may comprise hardware storage devices. The computing system manager 160 may manage the computing system 105 or aspects thereof (e.g., based on instructions stored in the memory 150 and executed by the processor 145) to perform functions ascribed herein to the computing system 105. In some examples, the network interface 140, processor 145, memory 150, and disk 155 may be included in a hardware layer of a server 125, and the computing system manager 160 may be included in a software layer of the server 125. In some cases, the computing system manager 160 may be distributed across (e.g., implemented by) multiple servers 125 within the computing system 105.

In some examples, the computing system 105 or aspects thereof may be implemented within one or more cloud computing environments, which may alternatively be referred to as cloud environments. Cloud computing may refer to Internet-based computing, wherein shared resources, software, and/or information may be provided to one or more computing devices on-demand via the Internet. A cloud environment may be provided by a cloud platform, where the cloud platform may include physical hardware components (e.g., servers) and software components (e.g., operating system) that implement the cloud environment. A cloud environment may implement the computing system 105 or aspects thereof through Software-as-a-Service (SaaS) or Infrastructure-as-a-Service (IaaS) services provided by the cloud environment. SaaS may refer to a software distribution model in which applications are hosted by a service provider and made available to one or more client devices over a network (e.g., to one or more computing devices 115 over the network 120). IaaS may refer to a service in which physical computing resources are used to instantiate one or more virtual machines, the resources of which are made available to one or more client devices over a network (e.g., to one or more computing devices 115 over the network 120).

In some examples, the computing system 105 or aspects thereof may implement or be implemented by one or more virtual machines. The one or more virtual machines may run various applications, such as a database server, an application server, or a web server. For example, a server 125 may be used to host (e.g., create, manage) one or more virtual machines, and the computing system manager 160 may manage a virtualized infrastructure within the computing system 105 and perform management operations associated with the virtualized infrastructure. The computing system manager 160 may manage the provisioning of virtual machines running within the virtualized infrastructure and provide an interface to a computing device 115 interacting with the virtualized infrastructure. For example, the computing system manager 160 may be or include a hypervisor and may perform various virtual machine-related tasks, such as cloning virtual machines, creating new virtual machines, monitoring the state of virtual machines, moving virtual machines between physical hosts for load balancing purposes, and facilitating backups of virtual machines. In some examples, the virtual machines, the hypervisor, or both, may virtualize and make available resources of the disk 155, the memory, the processor 145, the network interface 140, the data storage device 130, or any combination thereof in support of running the various applications. Storage resources (e.g., the disk 155, the memory 150, or the data storage device 130) that are virtualized may be accessed by applications as a virtual disk.

The DMS 110 may provide one or more data management services for data associated with the computing system 105 and may include DMS manager 190 and any quantity of storage nodes 185. The DMS manager 190 may manage operation of the DMS 110, including the storage nodes 185. Though illustrated as a separate entity within the DMS 110, the DMS manager 190 may in some cases be implemented (e.g., as a software application) by one or more of the storage nodes 185. In some examples, the storage nodes 185 may be included in a hardware layer of the DMS 110, and the DMS manager 190 may be included in a software layer of the DMS 110. In the example illustrated in FIG. 1, the DMS 110 is separate from the computing system 105 but in communication with the computing system 105 via the network 120. It is to be understood, however, that in some examples at least some aspects of the DMS 110 may be located within computing system 105. For example, one or more servers 125, one or more data storage devices 130, and at least some aspects of the DMS 110 may be implemented within the same cloud environment or within the same data center.

Storage nodes 185 of the DMS 110 may include respective network interfaces 165, processors 170, memories 175, and disks 180. The network interfaces 165 may enable the storage nodes 185 to connect to one another, to the network 120, or both. A network interface 165 may include one or more wireless network interfaces, one or more wired network interfaces, or any combination thereof. The processor 170 of a storage node 185 may execute computer-readable instructions stored in the memory 175 of the storage node 185 in order to cause the storage node 185 to perform processes described herein as performed by the storage node 185. A processor 170 may include one or more processing units, such as one or more CPUs, one or more GPUs, or any combination thereof. The memory 150 may comprise one or more types of memory (e.g., RAM, SRAM, DRAM, ROM, EEPROM, Flash, etc.). A disk 180 may include one or more HDDs, one or more SDDs, or any combination thereof. Memories 175 and disks 180 may comprise hardware storage devices. Collectively, the storage nodes 185 may in some cases be referred to as a storage cluster or as a cluster of storage nodes 185.

The DMS 110 may provide a backup and recovery service for the computing system 105. For example, the DMS 110 may manage the extraction and storage of snapshots 135 associated with different point-in-time versions of one or more target computing objects within the computing system 105. A snapshot 135 of a computing object (e.g., a virtual machine, a database, a filesystem, a virtual disk, a virtual desktop, or other type of computing system or storage system) may be a file (or set of files) that represents a state of the computing object (e.g., the data thereof) as of a particular point in time. A snapshot 135 may also be used to restore (e.g., recover) the corresponding computing object as of the particular point in time corresponding to the snapshot 135. In some cases, a computing object that is the subject of a snapshot 135 may be or include a collection of multiple objects (e.g., computing objects may have hierarchical relationships, with lower-level computing objects included within one or more higher-level computing objects). For example, a filesystem may include multiple files, and along with the filesystem being a computing object, the files therein may also be computing objects. Or, as another example, a database may include multiple tables, and along with the database being a computing object, the tables therein may also be computing objects. Thus, a snapshot may be of one or more computing objects, and a snapshot of a first computing object (e.g., a higher-level computing object) may also be a snapshot of each computing object (e.g., each lower-level computing object) that is included in (e.g., is a member or component of) the first computing object. Additionally, a snapshot may be of one or more lower-level computing objects individually (e.g., a snapshot of a lower-level computing object may be separate from another snapshot of another lower-level computing object, separate from another snapshot of a higher-level computing object that contains the lower-level computing object, or both).

A computing object of which a snapshot 135 may be generated may be referred to as snappable. Snapshots 135 may be generated at different times (e.g., periodically or on some other scheduled or configured basis) in order to represent the state of the computing system 105 or aspects thereof as of those different times. In some examples, a snapshot 135 may include metadata that defines a state of the computing object as of a particular point in time. For example, a snapshot 135 may include metadata associated with (e.g., that defines a state of) some or all data blocks included in (e.g., stored by or otherwise included in) the computing object. Snapshots 135 (e.g., collectively) may capture changes in the data blocks over time. Snapshots 135 generated for the target computing objects within the computing system 105 may be stored in one or more storage locations (e.g., the disk 155, memory 150, the data storage device 130) of the computing system 105, in the alternative or in addition to being stored within the DMS 110, as described below.

To obtain a snapshot 135 of a target computing object associated with the computing system 105 (e.g., of the entirety of the computing system 105 or some portion thereof, such as one or more databases, virtual machines, or filesystems within the computing system 105), the DMS manager 190 may transmit a snapshot request to the computing system manager 160. In response to the snapshot request, the computing system manager 160 may set the target computing object into a frozen state (e.g., a read-only state). Setting the target computing object into a frozen state may allow a point-in-time snapshot 135 of the target computing object to be stored or transferred.

In some examples, the computing system 105 may generate the snapshot 135 based on the frozen state of the computing object. For example, the computing system 105 may execute an agent of the DMS 110 (e.g., the agent may be software installed at and executed by one or more servers 125), and the agent may cause the computing system 105 to generate the snapshot 135 and transfer the snapshot 135 to the DMS 110 in response to the request from the DMS 110. In some examples, the computing system manager 160 may cause the computing system 105 to transfer, to the DMS 110, data that represents the frozen state of the target computing object, and the DMS 110 may generate a snapshot 135 of the target computing object based on the corresponding data received from the computing system 105.

Once the DMS 110 receives, generates, or otherwise obtains a snapshot 135, the DMS 110 may store the snapshot 135 at one or more of the storage nodes 185. The DMS 110 may store a snapshot 135 at multiple storage nodes 185, for example, for improved reliability. Additionally, or alternatively, snapshots 135 may be stored in some other location connected with the network 120. For example, the DMS 110 may store more recent snapshots 135 at the storage nodes 185, and the DMS 110 may transfer less recent snapshots 135 via the network 120 to a cloud environment (which may include or be separate from the computing system 105) for storage at the cloud environment, a magnetic tape storage device, or another storage system separate from the DMS 110.

Updates made to a target computing object that has been set into a frozen state may be written by the computing system 105 to a separate file (e.g., an update file) or other entity within the computing system 105 while the target computing object is in the frozen state. After the snapshot 135 (or associated data) of the target computing object has been transferred to the DMS 110, the computing system manager 160 may release the target computing object from the frozen state, and any corresponding updates written to the separate file or other entity may be merged into the target computing object.

In response to a restore command (e.g., from a computing device 115 or the computing system 105), the DMS 110 may restore a target version (e.g., corresponding to a particular point in time) of a computing object based on a corresponding snapshot 135 of the computing object. In some examples, the corresponding snapshot 135 may be used to restore the target version based on data of the computing object as stored at the computing system 105 (e.g., based on information included in the corresponding snapshot 135 and other information stored at the computing system 105, the computing object may be restored to its state as of the particular point in time). Additionally, or alternatively, the corresponding snapshot 135 may be used to restore the data of the target version based on data of the computing object as included in one or more backup copies of the computing object (e.g., file-level backup copies or image-level backup copies). Such backup copies of the computing object may be generated in conjunction with or according to a separate schedule than the snapshots 135. For example, the target version of the computing object may be restored based on the information in a snapshot 135 and based on information included in a backup copy of the target object generated prior to the time corresponding to the target version. Backup copies of the computing object may be stored at the DMS 110 (e.g., in the storage nodes 185) or in some other location connected with the network 120 (e.g., in a cloud environment, which in some cases may be separate from the computing system 105).

In some examples, the DMS 110 may restore the target version of the computing object and transfer the data of the restored computing object to the computing system 105. And in some examples, the DMS 110 may transfer one or more snapshots 135 to the computing system 105, and restoration of the target version of the computing object may occur at the computing system 105 (e.g., as managed by an agent of the DMS 110, where the agent may be installed and operate at the computing system 105).

In response to a mount command (e.g., from a computing device 115 or the computing system 105), the DMS 110 may instantiate data associated with a point-in-time version of a computing object based on a snapshot 135 corresponding to the computing object (e.g., along with data included in a backup copy of the computing object) and the point-in-time. The DMS 110 may then allow the computing system 105 to read or modify the instantiated data (e.g., without transferring the instantiated data to the computing system). In some examples, the DMS 110 may instantiate (e.g., virtually mount) some or all of the data associated with the point-in-time version of the computing object for access by the computing system 105, the DMS 110, or the computing device 115.

In some examples, the DMS 110 may store different types of snapshots 135, including for the same computing object. For example, the DMS 110 may store both base snapshots 135 and incremental snapshots 135. A base snapshot 135 may represent the entirety of the state of the corresponding computing object as of a point in time corresponding to the base snapshot 135. A base snapshot 135 may alternatively be referred to as a full snapshot 135. An incremental snapshot 135 may represent the changes to the state—which may be referred to as the delta—of the corresponding computing object that have occurred between an earlier or later point in time corresponding to another snapshot 135 (e.g., another base snapshot 135 or incremental snapshot 135) of the computing object and the incremental snapshot 135. In some cases, some incremental snapshots 135 may be forward-incremental snapshots 135 and other incremental snapshots 135 may be reverse-incremental snapshots 135. To generate a base snapshot 135 of a computing object using a forward-incremental snapshot 135, the information of the forward-incremental snapshot 135 may be combined with (e.g., applied to) the information of an earlier base snapshot 135 of the computing object along with the information of any intervening forward-incremental snapshots 135, where the earlier base snapshot 135 may include a base snapshot 135 and one or more reverse-incremental or forward-incremental snapshots 135. To generate a base snapshot 135 of a computing object using a reverse-incremental snapshot 135, the information of the reverse-incremental snapshot 135 may be combined with (e.g., applied to) the information of a later base snapshot 135 of the computing object along with the information of any intervening reverse-incremental snapshots 135.

In some examples, the DMS 110 may provide a data classification service, a malware detection service, a data transfer or replication service, backup verification service, or any combination thereof, among other possible data management services for data associated with the computing system 105. For example, the DMS 110 may analyze data included in one or more computing objects of the computing system 105, metadata for one or more computing objects of the computing system 105, or any combination thereof, and based on such analysis, the DMS 110 may identify locations within the computing system 105 that include data of one or more target data types (e.g., sensitive data, such as data subject to privacy regulations or otherwise of particular interest) and output related information (e.g., for display to a user via a computing device 115). Additionally, or alternatively, the DMS 110 may detect whether aspects of the computing system 105 have been impacted by malware (e.g., ransomware). Additionally, or alternatively, the DMS 110 may relocate data or create copies of data based on using one or more snapshots 135 to restore the associated computing object within its original location or at a new location (e.g., a new location within a different computing system 105). Additionally, or alternatively, the DMS 110 may analyze backup data to ensure that the underlying data (e.g., user data or metadata) has not been corrupted. The DMS 110 may perform such data classification, malware detection, data transfer or replication, or backup verification, for example, based on data included in snapshots 135 or backup copies of the computing system 105, rather than live contents of the computing system 105, which may beneficially avoid adversely affecting (e.g., infecting, loading, etc.) the computing system 105.

In some examples, the DMS 110, and in particular the DMS manager 190, may be referred to as a control plane. The control plane may manage tasks, such as storing data management data or performing restorations, among other possible examples. The control plane may be common to multiple customers or tenants of the DMS 110. For example, the computing system 105 may be associated with a first customer or tenant of the DMS 110, and the DMS 110 may similarly provide data management services for one or more other computing systems associated with one or more additional customers or tenants. In some examples, the control plane may be configured to manage the transfer of data management data (e.g., snapshots 135 associated with the computing system 105) to a cloud environment 195 (e.g., Microsoft Azure or Amazon Web Services). In addition, or as an alternative, to being configured to manage the transfer of data management data to the cloud environment 195, the control plane may be configured to transfer metadata for the data management data to the cloud environment 195. The metadata may be configured to facilitate storage of the stored data management data, the management of the stored management data, the processing of the stored management data, the restoration of the stored data management data, and the like.

Each customer or tenant of the DMS 110 may have a private data plane, where a data plane may include a location at which customer or tenant data is stored. For example, each private data plane for each customer or tenant may include a node cluster 196 across which data (e.g., data management data, metadata for data management data, etc.) for a customer or tenant is stored. Each node cluster 196 may include a node controller 197 which manages the nodes 198 of the node cluster 196. As an example, a node cluster 196 for one tenant or customer may be hosted on Microsoft Azure, and another node cluster 196 may be hosted on Amazon Web Services. In another example, multiple separate node clusters 196 for multiple different customers or tenants may be hosted on Microsoft Azure. Separating each customer or tenant's data into separate node clusters 196 provides fault isolation for the different customers or tenants and provides security by limiting access to data for each customer or tenant.

The control plane (e.g., the DMS 110, and specifically the DMS manager 190) manages tasks, such as storing backups or snapshots 135 or performing restorations, across the multiple node clusters 196. For example, as described herein, a node cluster 196-a may be associated with the first customer or tenant associated with the computing system 105. The DMS 110 may obtain (e.g., generate or receive) and transfer the snapshots 135 associated with the computing system 105 to the node cluster 196-a in accordance with a service level agreement for the first customer or tenant associated with the computing system 105. For example, a service level agreement may define backup and recovery parameters for a customer or tenant such as snapshot generation frequency, which computing objects to backup, where to store the snapshots 135 (e.g., which private data plane), and how long to retain snapshots 135. As described herein, the control plane may provide data management services for another computing system associated with another customer or tenant. For example, the control plane may generate and transfer snapshots 135 for another computing system associated with another customer or tenant to the node cluster 196-n in accordance with the service level agreement for the other customer or tenant.

To manage tasks, such as storing backups or snapshots 135 or performing restorations, across the multiple node clusters 196, the control plane (e.g., the DMS manager 190) may communicate with the node controllers 197 for the various node clusters via the network 120. For example, the control plane may exchange communications for backup and recovery tasks with the node controllers 197 in the form of transmission control protocol (TCP) packets via the network 120.

The DMS 110 may obtain backups of computing objects in a client's system (e.g., the computing system 105) at different times during operation and may store the backups in memory (e.g., at one or more storage nodes 185, at one or more node clusters 196 within the cloud environment 195, or elsewhere). The client may request to restore or otherwise recover their system to a certain state by selecting a previous backup, and the DMS 110 may facilitate restoration of the client's system to the state corresponding to the time associated with the selected backup. In some examples, the DMS 110 may backup a clients system directory, which may be referred to as an active directory in some examples herein. The directory may include a database within the computing system 105 or elsewhere that supports management of various objects and data within the client's system. For example, the directory may include multiple directory objects, which may be, for example, users, tenants, groups, hierarchies, or the like. Each object in the directory may be associated with (e.g., defined by) a set of one or more attributes. For example, a user may be associated with a set of attributes including, for example, an email of the user, an office location of the user, a supervisor of the user, one or more groups to which the user belongs, one or more direct reports to the user, and the like. Some of the attributes may be linked attributes. For example, the one or more groups to which the user belongs may be linked to other directory objects in the directory. That is, if the user belongs to a group 1 and a group 2, the user's group 1 and group 2 attributes may be linked to a group 1 directory object and a group 2 directory object. Accordingly, if the DMS 110 recovers the client directory and all directory objects to a previous state in response to a request, some of the links may be broken or otherwise unrecoverable. For example, if the group 1 is deleted from the directory, and the DMS 110 restores the user to its corresponding attributes at a first time, the DMS 110 may restore a linked attribute that links to the deleted group 1, which may cause an error.

Techniques for the user to preview the recovery before requesting the recovery is performed may be beneficial by, for example, allowing the user to review whether any existing (e.g., live) attributes in the client's system are going to be overwritten, or whether other changes (e.g., additions or deletions) made after the time of the backup corresponding to the requested recovery state are going to be accounted for or otherwise preserved in the recovery without errors (e.g., faulty links).

Techniques described herein provide for the DMS 110 to perform a merge operation in response to a recovery request and to output an initial preview (e.g., a mock recovery) of a result of the merge operation via a user interface for the user to review (e.g., via a computing device 115). The user may decide whether to perform the actual recovery or to correct one or more errors in the system before performing the recovery based on the preview. The merge operation may account for (e.g., preserve) changes in directory objects and attributes that occurred after the requested recovery time. For example, the DMS 110 may merge backup values from the requested backup with live values of the data in the live (current) version of the client's system directory (e.g., a directory of the computing system 105). Values that were deleted from the directory after the requested recovery time may not be available for inclusion in the merge, but other values that were added to or otherwise modified in the directory after generation of the backup corresponding to the requested recovery time may be available for inclusion in the merge.

The DMS 110 may display, via a user interface (e.g., to the user via the network 120, the computing device 115, or some other user interface or devices), a result of the merge. The user may review the displayed results and decide whether to request the DMS 110 to perform the recovery and overwrite a live state of at least one or more attributes in the user's system with the displayed results or whether to perform one or more other operations to avoid potential errors and/or preserve more recently updated or added values before enabling the recovery. For example, if one or more attributes were in the backup at the requested recovery time and were subsequently deleted from the directory, the merge results may not include those attributes, and the customer may determine whether to overwrite the live state with the merge results (which would exclude those attributes) or to delay the recovery while separately recovering the one or more attributes back to the directory before performing another merge and overwriting the live states, among other examples that may improve the reliability and accuracy of data recovery.

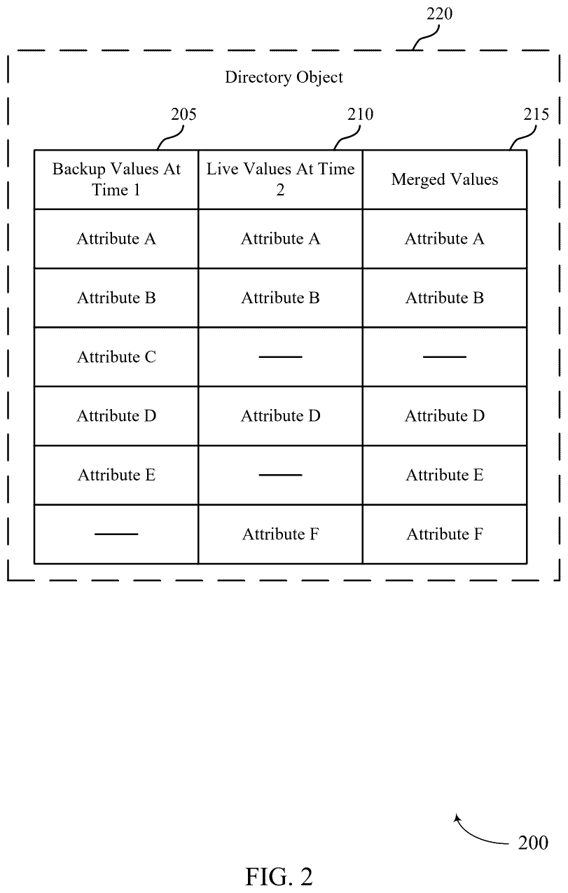

FIG. 2 shows an example of a merge preview configuration 200 that supports preview for merge operation in recovery in accordance with aspects of the present disclosure. The merge preview configuration may implement or be implemented by aspects of the computing environment 100, as described with reference to FIG. 1. For example, the merge preview configuration 200 illustrates an example merged state that may be generated by a DMS 110 as part of a merge operation in response to a recovery request from a user (e.g., via a computing device 115), as described with reference to FIG. 1.

The DMS 110 may obtain and store backups of a client's system, and, more specifically, a directory associated with the client's system, over time. If the client's system experiences a failure or other corruption, among other examples, the client may benefit from recovering their system and/or directory to a previous point-in-time using the backups stored by the DMS 110. In some cases, however, client administrators may lack a real-time view of how the recovered state may appear. For example, access authorization information, user information, and other attribute information may be removed from the directory and may be subsequently unrecoverable, among other examples, such that simply overwriting the data with a previous point-in-time backup version may not successfully recover the directory. Techniques for a client to overwrite existing elements (e.g., attributes) within the directory while preserving changes to new elements made after a certain date and time may be beneficial by reducing errors and improving reliability and success associated with recovery processes.

As described herein, to improve recovery processes, in response to a recovery request, the DMS 110 may perform a merge operation to merge backup values with live values of attributes within the client's directory, and the DMS 110 may provide a user with a representation of a merged state of their directory. The DMS 110 may output the representation of the merged state via a user interface, which may be referred to as a preview or a mock recovery feature. The DMS 110 may perform the merge operation to incorporate or apply any changes to attributes of directory objects between the requested recovery time and a live or current time. Additionally, the preview may provide for the client to simulate recovery and preview any potential impacts of the merge operation on their directory and associated system before actually overwriting any data. The client may thereby confidently apply changes to their live environment (e.g., directory) with fully visibility first into the expected outcome. For example, the client may determine whether to execute the actual recovery or not based on reviewing the preview of the merged state, which may ensure relatively granular control and may reduce potential risks to client data during recovery.

The recovery may begin when a client enters a user interface for the DMS 110 and selects, from among all directory objects and corresponding attributes within the client's directory, which directory objects and which corresponding attributes the client would like to recover. A directory object as described herein may refer to one or more objects of the client's system that are listed in or otherwise included in the directory, such as users of the client's data, tenants, groups, various types of objects, or any combination thereof. In some examples, the client may select a single directory object 220 and one or more associated attributes for recovery, and the merge may indicate changes to the selected attributes of the single directory object 220, which may be a single group, a single user, or the like. The client may select which attributes the client would like to include in the merge. In some other examples, the client may select, from among multiple snapshots or backups of the client's directory, a snapshot for recovery. In such cases, the DMS 110 may output, via the user interface, a representation of all directory objects and corresponding attributes within the selected snapshot, and the client may further select all or a subset of one or more directory objects in the snapshot to include in the merge. The client may further select certain attributes for each selected directory object for recovery.

The client may subsequently select, in the user interface, how the client would like to perform the recovery. For example, the client may, in some examples, request a restore over original operation (e.g., overwrite attribute values). In such cases, the DMS 110 may respond by overwriting live states of the client's directory with backup states of the client's directory as captured in a backup previously obtained by the DMS 110 and associated with a recovery time indicated via the recovery request. However, such a restoration may incur various errors including, for example, by not including some attributes which may have been deleted from the client's directory since the recovery time, or by not including new additions to the client's directory since the recovery time, or otherwise not accounting for various changes between the recovery time and a current time at which the recovery is performed.

Additionally, or alternatively, the client may select, via the user interface, to perform a merge preview recovery (e.g., merge attribute values). A merge preview recovery may request the DMS 110 to perform a merge operation to merge a live state of the selected attributes in the client's directory at a current time (e.g., a time at which the request is received) with a backup state of the selected attributes as of the requested recovery time. The merge preview recovery may further include the DMS 110 outputting a preview of the resulting merged state before performing any actual recovery (e.g., before overwriting any live data in the client's directory).

If the client requests a merge preview recovery, the client may indicate a recovery time and one or more attributes for recovery. The client may check a confirmation page and receive, via the user interface, a loading banner communicating that the merge operation is taking place and will take a few minutes. The client may either recover without waiting for and viewing the final view (e.g., in an urgent situation), or may wait to receive, via the user interface, a preview showing final values that would be written to the client's directory (e.g., active directory) if they approve of the actual recovery using the merged state. If the client requests to recover without waiting for the final view, the DMS 110 may overwrite live states of the attributes in the client's directory with a merged state of the attributes (e.g., once the merge is complete). If the client waits, the DMS 110 may output a representation of the merged state via the user interface.

In some examples, the DMS 110 may perform the merge preview for linked attributes, and may recover other attributes (e.g., non-linked attributes) without performing a merge. A linked attribute may be an attribute that stores information about a relationship between two or more directory objects, while a non-linked attribute may be an attribute used to describe information about the directory object itself. For example, a linked attribute may be either a back link or a forward link within a linked attribute pair, where the values of the back link are based on values set in the forward link. As an example, if a directory object is a user, one or more non-linked attributes may include a name of the user, an email of the user, or the like, and one or more linked attributes may include one or more other users that report to the user, a supervisor of the user, one or more groups to which the user belongs, or the like. For example, when the user is moved from a group 1 to a group 2, the user's attributes may be updated, which may automatically update the attributes of the corresponding group 1 and group 2 directory objects.

With reference to FIG. 2, the client may request to restore a set of attributes associated with a directory object 220 to a recovery time T1 via a merge preview recovery. In this example, the directory object 220 may be a user group, and the attributes may be attributes defining users within the user group. Additionally, or alternatively, the directory object 220 may be a user, and the attributes may include a name of the user, an email of the user, one or more groups that include the user, and the like. The DMS 110 may retrieve a previously obtained backup of the client's computing system at the recovery time T1, which may indicate a set of backup values 205 of attributes included in the directory object 220 at the recovery time T1. For example, the directory object 220 may include the attributes A through E at the time T1, and each attribute may be associated with respective values. The set of backup values 205 and the set of live values 210 may each represent examples of attribute values of the directory object 220 at respective times.

Once the client selects the merge recovery and clicks next in the user interface, the DMS 110 may initiate a mock recovery. The mock recovery (e.g., a merge operation) may be triggered in response to the client clicking next and before a confirmation page is output via the user interface to reduce a loading time within the confirmation page (e.g., by a few seconds). The DMS 110 may output, via the confirmation page or a subsequent view within the user interface, a representation of a backup state of the directory object 220 at the requested recovery time T1. That is, the DMS 110 may output, via the user interface, a representation of the set of backup values 205. The DMS 110 may additionally output an indication that the merge preview is loading while the DMS 110 performs the merge.

The DMS 110 may perform a merge in a separate environment within the DMS 110. For example, the mock merge may be performed via a different API than an API used for an actual recovery. In some examples, the mock merge may be performed within one or more virtual resources, or within a sandboxed environment within or otherwise coupled with or accessible to the DMS 110. The merge may include checking a backup state of the attributes at the recovery time T1, checking a live state of the attributes at a current time, and creating a merge between the two to obtain a final merged result. In the example of FIG. 2, the DMS 110 may observe a set of live values 210 of the directory object 220 at a current time, T2, which may be a time at which the request is received or a time at which the merge is being performed.

The DMS 110 may merge the set of live values 210 with the set of backup values 205 to obtain the set of merged values 215, which may represent an example of a merged state of the directory object 220. As described herein, the merged state may include any attributes that were originally included in or otherwise associated with the directory object 220 at the recovery time T1, as well as any new attributes that have been added to the description of the directory object 220 since the recovery time T1 (e.g., between the time T1 and the current time T2). For example, although Attribute F was not associated with the directory object 220 at the recovery time T1, the DMS 110 may include the Attribute F in the set of merged values 215 because the Attribute F may have been added as a descriptor for the directory object 220 between the recovery time T1 and the current time T2.

The Attribute E may have been associated with the directory object 220 at the recovery time T1, and may have been subsequently removed from directory object 220 before the current time T2. For example, if the directory object 220 is a group, the Attribute E may define a user that is included in the group at the time T1 and that is removed from the group before the current time T2. The DMS 110 may still include the Attribute E in the set of merged values 215 if the Attribute E is still in the client's system (e.g., within an active directory). If, however, an attribute (e.g., or the element to which a linked attribute points) is removed from the client's system altogether between the recovery time T1 and the current time T2, the DMS 110 may not include such attributes in the set of merged values 215. For example, the Attribute C may have been included in or otherwise used to define the directory object 220 and the set of backup values 205 at the time T1, but may have subsequently been removed from the client's system altogether. That is, the Attribute C may be removed from both the description of the directory object 220 and the overall client's directory between the time T1 and the time T2 (e.g., may no longer exist as a user, as an object, or the like, or may point to a no longer existing user, object, or the like). In such cases, the DMS 110 may not be capable of retrieving the Attribute C, and the Attribute C may thereby not be included in the set of merged values 215.

Once the merge is complete (e.g., if successful), a response may be returned from the merge environment (e.g., the mock recovery API) to indicate the merge view. Additionally, or alternatively, in some examples, the entire merge preview may fail, and the DMS 110 may output an indication of the failure. In such cases, the user may select, within the user interface, to still go through with the recovery without a merge (e.g., to recover directly to the state as of the recovery time T1). The DMS 110 may populate the confirmation page in the user interface with the failure indication or with the merged view, which may be a representation of a merged state of the directory object 220.

The DMS 110 may output one or more indications associated with a status of the set of merged values 215 via the user interface with the representation of the merged state. For example, the DMS 110 may output an indication that the Attribute C was unable to be included within the set of merged values 215 due to the Attribute C being removed from the client's system. Additionally, or alternatively, the DMS 110 may output an indication that the Attribute F was not included in the original state of the directory object 220 at the time T1,among other example indications. In some examples, one or more attribute values may fail to merge, and the DMS 110 may output an indication of which attributes experienced merge failures.

The user may thereby preview a result of the merge operation (e.g., the set of merged values 215) within the user interface and determine whether to perform an actual recovery using the set of merged values 215 or not. For example, the client may determine to proceed with the actual recovery using the set of merged values 215, and the client may transmit a request (e.g., select or click a recover button in the user interface) to the DMS 110 to perform the recovery. The DMS 110 may overwrite the set of live values 210 within the client's directory with the set of merged values 215 in response to the request. That is, the DMS 110 may erase the set of live values 210 and may write the set of merged values 215. In such cases, the merged values from the mock recovery environment may be written to the main environment within the client's directory. Additionally, or alternatively, the client may transmit a request (e.g., refrain from further selections or otherwise select or click a do not recover button in the user interface) to the DMS 110 to refrain from performing the actual recovery using the set of merged values 215. For example, if the client sees that the Attribute C is unrecoverable, the client may benefit from delaying any recovery until the client is able to separately recover the Attribute C back to the client's system. For example, if the directory object 220 is a group, and the Attribute C is a linked attribute that points to a user that has been deleted from the client's directory, the client may separately recover the user back to the directory before re-requesting the directory recovery. In such cases, the DMS 110 may maintain the set of live values 210 within the client's system and may erase or otherwise maintain the set of merged values 215 in the mock recovery environment. The DMS 110 may erase the mock recovery environment immediately after receiving the request to refrain from recovery, or the DMS 110 may maintain the set of merged values 215 in the mock recovery environment for a threshold time period or until one or more other conditions are met (e.g., until a subsequent mock recovery request is received).

As described herein, the merge preview techniques may be applied to any linked attributes. In some examples, one or more of the attributes may not be linked among other examples. In such cases, in response to a request from the user to perform a merge recovery preview, the DMS 110 may generate the merged values 215 for any linked attributes, and may directly recovery any non-linked attributes using the state of those non-linked attributes as of the requested recovery time T1.

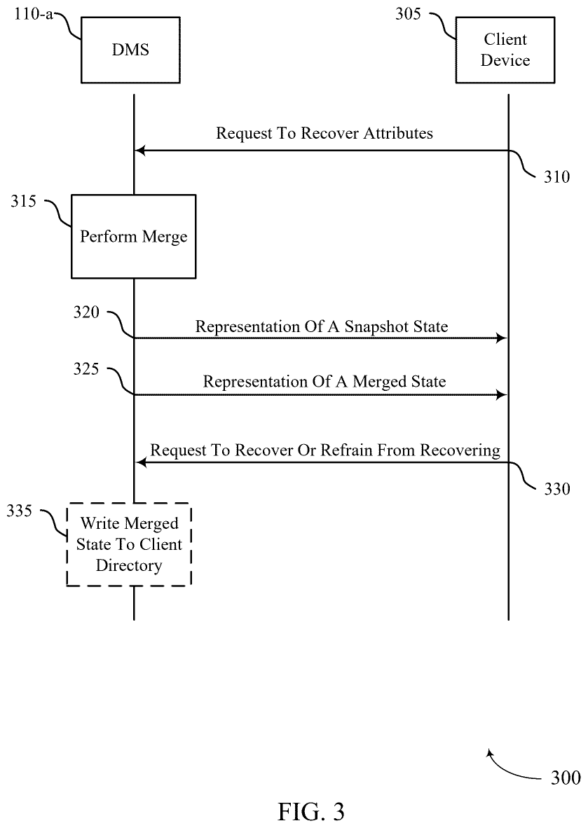

FIG. 3 shows an example of a process flow 300 that supports preview for merge operation in recovery in accordance with aspects of the present disclosure. The process flow 300 may implement or be implemented by aspects of the computing environment 100 and the merge preview configuration 200, as described with reference to FIGS. 1 and 2. For example, the process flow 300 may be implemented by a DMS 110-a and a client device 305, which may represent examples of a DMS 110 and a computing device 115, respectively, as described with reference to FIGS. 1 and 2. In some examples, a user (e.g., a client administrator or other client user) may use the client device 305 to access a user interface and communicate with the DMS 110-a, which may manage backup and recovery operations for the client's data. As described herein, the DMS 110-a may perform a mock recovery by merging backup values with live values of one or more attributes within the client's system, and may output a preview of the merge before overwriting any of the client's actual data.

In the following description of the process flow 300, the operations between the DMS 110-a and the client device 305 may occur in a different order than the example order shown and, in some examples, may be performed by one or more different devices other than those shown as examples. Some operations also may be omitted from the process flow 300, and other operations may be added to the process flow 300. Further, although some operations or signaling may be shown to occur at different times for discussion purposes, these operations may actually occur at the same time.

At 310, the client device 305 may send, to the DMS 110-a via a user interface, a first request to recover one or more attributes associated with one or more directory objects within a directory of the client's system. The first request may indicate which directory object(s) and which corresponding attribute(s) the client wants to recover and a first time corresponding to a prior backup of the one or more attributes. The first time may be referred to as a recovery time in some examples herein, and may represent an example of the time T1 in FIG. 2. As described with reference to FIG. 2, the client may either select a single object and one or more attributes associated with the single object for recovery, or the client may select a snapshot (e.g., the prior backup at the first time), and may subsequently be redirected to a screen in the user interface that requests further selection of one or more directory objects from all directory objects included in the snapshot, as well as selection of one or more attributes associated with the selected directory objects.

After transmitting the first request to recover the selected directory object(s) and corresponding attribute(s) to the first time, the client device 305 may select a type of recovery. Additionally, or alternatively, the first request may include or otherwise indicate a type of the recovery. For example, the client device 305, may transmit, to the DMS 110-a via the user interface, an indication of whether the client would like to perform a direct recovery or a merge recovery. If the client device 305 indicates a direct recovery, the DMS 110-a may overwrite live states of the selected attributes in the client's directory with a state of the attributes as included in the selected prior backup. In the example of FIG. 3, the client device 305 may request a merge recovery.

At 315, the DMS 110-a may perform the merge in response to the first request. For example, the DMS 110-a may merge a first state of the selected attributes as of the first time indicated via the first request with a live state of the one or more selected attributes as of a second time at which the merge is performed. In some examples, the first state may represent an example of the set of backup values 205, and the live state may represent an example of the set of live values 210, as described with reference to FIG. 2. The DMS 110-a may obtain the first state from a previously obtained backup of the directory including the selected attributes, and the DMS 110-a may obtain the live state directly from the client's computing directory (e.g., by reading, mounting, or otherwise pulling values from the client's directory).

The DMS 110-a may generate a representation of a merged state (e.g., a set of merged values 215) after performing the merge. The representation of the merged state may include attributes included in the first state as of the first time indicated via the request as well as attributes included in the live state. If the DMS 110-a, the client, or both modify one or more attributes of one or more of the selected directory objects between the first time and the second time at which the merge is performed, the representation of the merged state may include or otherwise indicate attributes of the selected directory objects as of the first time and also attributes of the selected directory objects as of the second time. However, the representation of the merged state may exclude one or more attributes that were included in or otherwise point to objects included in the first state as of the first time, but were subsequently deleted or removed from or otherwise point to objects that were subsequently deleted or removed the client's system (e.g., removed from an active directory, removed as a user) before the merge is performed. Examples of how various attributes may be merged are described in further detail elsewhere herein, including with reference to FIG. 2.

The DMS 110-a may perform the merge without overwriting or otherwise changing the live state of the attributes in the client's directory. For example, the DMS 110-a may perform the merge in a sandboxed environment, using a separate API than an API used for direct recovery, or both. The DMS 110-a may perform a similar logical operation as performed during direct recovery, but the DMS 110-a may not directly modify any live values within the client directory. As such, the merge may be referred to as a mock recovery or a preview merge, in some examples herein.

At 320, the DMS 110-a may output, via the user interface of the DMS 110-a and to the client device 305, a representation of the first state of the one or more selected attributes as of the first time. In some examples, the DMS 110-a may output the representation of the first state of the one or more selected attributes before the merge is complete. For example, the DMS 110-a may output the representation of the first state of the one or more selected attributes in response to the first request, and the DMS 110-a may additionally output a merge processing indication that indicates the merge is processing, an estimated time until completion of the merge, or both. In some examples, the DMS 110-a may output, via the user interface, an option for the client to perform a direct recovery of the one or more selected attributes to the first state as of the first time.

At 325, the DMS 110-a may output, via the user interface of the DMS 110-a and to the client device 305, a representation of the merged state of the one or more selected attributes after the merge is complete. In some examples, the representation of the merged state may replace the merge processing indication within the user interface once the merge is complete. The user interface may thereby display the first state of the one or more selected attributes as of the first time next to the merged state of the one or more attributes, such that the client may compare the two states.

In some examples, the DMS 110-a may remove, between the first time and the second time, a first attribute from a directory group (e.g., a directory object, a user group) indicated via the first request. For example, the client may request that the first attribute be removed from (e.g., no longer included in or otherwise used to describe) a certain directory object, but remain within the client's directory. In such cases, a third state of the directory object as of the second time at which the merge is performed may exclude the first attribute, but the representation of the merged state of the directory object may include the first attribute based on the first attribute remaining within the directory of active directory objects authorized within the client system at the second time. In some other examples, the DMS 110-a may add, between the first time and the second time, a first attribute to the directory object indicated via the first request (e.g., in response to a request from the client). In such cases, the first state of the directory object as of the first time indicated via the request may not include the first attribute, but the representation of the merged state of the directory object may include the first attribute.

In some examples, the DMS 110-a may output, via the user interface with the representation of the merged state, one or more notifications or other indications associated with the merged state. For example, the DMS 110-a may output an indication that a first attribute of the selected attributes was deleted from a directory of active attributes and directory objects authorized within the client's system between the first time and the second time and is thereby excluded from the merged state. That is, if the client deletes or unauthorizes one or more attributes or directory objects to which one or more attributes point between the first time and the second time, the DMS 110-a may not include those attributes in the merged state, and the DMS 110-a may output a notification in the user interface to indicate that those attributes are not included. Additionally, or alternatively, the DMS 110-a may output one or more indications if any attributes fail to be merged, among other examples.

At 330, the client device 305 may transmit, to the DMS 110-a via the user interface, a second request that indicates whether the DMS 110-a is to recover the one or more selected attributes in accordance with the merged state or not. For example, after outputting the merge preview, the DMS 110-a may output an option for the client to either authorize recovery using the merged state or refrain from recovering using the merged state. The client's selection in the user interface may be transmitted to the DMS 110-a in the form of the second request. The client may make the selection based on a comparison between the representation of the first state of the selected attributes as of the first time and the representation of the merged state of the selected attributes, as described in further detail elsewhere herein, including with reference to FIG. 2.

If the client requests to refrain from recovering the one or more attributes according to the merged state, the DMS 110-a may maintain the live state of the one or more attributes in the client's directory after performing the merge. That is, the DMS 110-a may not overwrite the existing live values of the attributes. In such cases, the client may transmit one or more third requests for the DMS 110-a to use a different snapshot to perform another merge recovery, or for the DMS 110-a to recover different objects or attributes, or both. Additionally, or alternatively, the client may perform one or more other types of recovery options to, for example, recover one or more attributes or objects to which one or more attributes point back to the client's system, among other examples.

At 335, if the second request indicates that the DMS 110-a is to recover the one or more selected attributes to the merged state, the DMS 110-a may perform the recovery and write the merged state to the client's directory. For example, the DMS 110-a may erase a live state of the one or more attributes from the client directory, and may write the merged state to the client directory (e.g., overwrite the live state).

The DMS 110-a as described herein may thereby support a merged recovery and corresponding preview operation, which may provide for a client to preview what a merged recovery might look like before performing the actual recovery. The described techniques may provide for improved reliability of recovery operations, improved user experience, and improved performance of the DMS 110-a, among other examples.

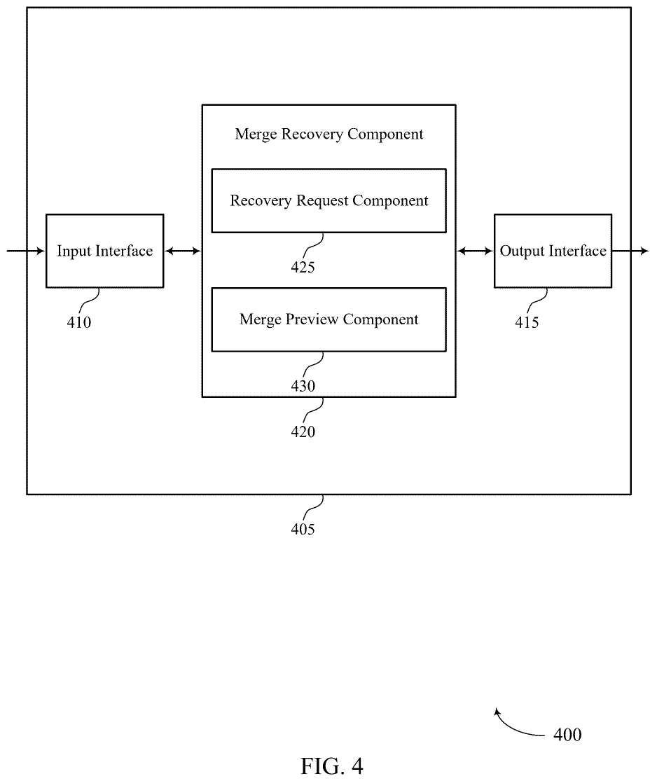

FIG. 4 shows a block diagram 400 of a system 405 that supports preview for merge operation in recovery in accordance with aspects of the present disclosure. In some examples, the system 405 may be an example of aspects of one or more components described with reference to FIG. 1, such as a DMS 110. The system 405 may include an input interface 410, an output interface 415, and a merge recovery component 420. The system 405 may also include one or more processors. Each of these components may be in communication with one another (e.g., via one or more buses, communications links, communications interfaces, or any combination thereof).

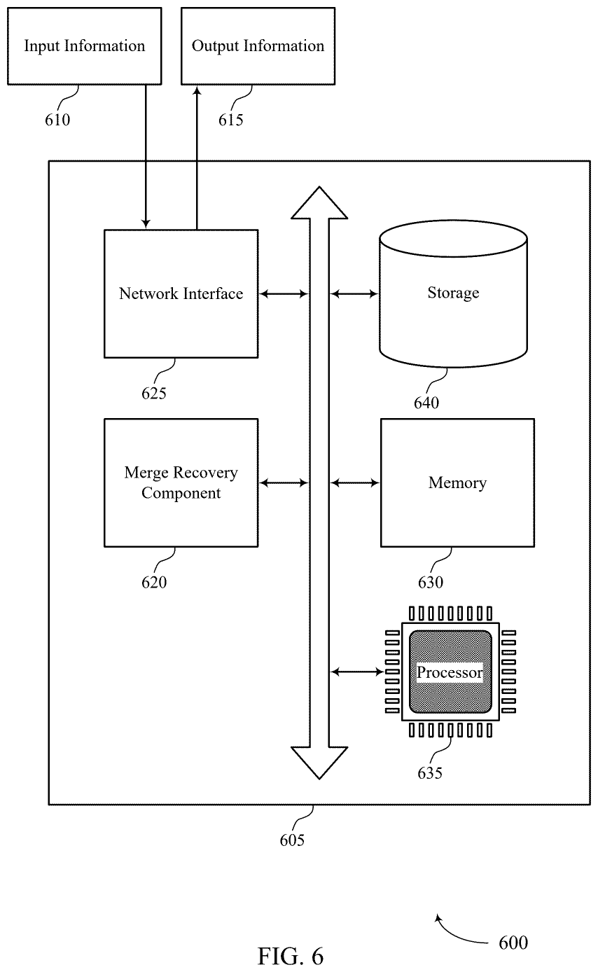

The input interface 410 may manage input signaling for the system 405. For example, the input interface 410 may receive input signaling (e.g., messages, packets, data, instructions, commands, or any other form of encoded information) from other systems or devices. The input interface 410 may send signaling corresponding to (e.g., representative of or otherwise based on) such input signaling to other components of the system 405 for processing. For example, the input interface 410 may transmit such corresponding signaling to the merge recovery component 420 to support preview for merge operation in recovery. In some cases, the input interface 410 may be a component of a network interface 625 as described with reference to FIG. 6.

The output interface 415 may manage output signaling for the system 405. For example, the output interface 415 may receive signaling from other components of the system 405, such as the merge recovery component 420, and may transmit such output signaling corresponding to (e.g., representative of or otherwise based on) such signaling to other systems or devices. In some cases, the output interface 415 may be a component of a network interface 625 as described with reference to FIG. 6.

For example, the merge recovery component 420 may include a recovery request component 425 a merge preview component 430, or any combination thereof. In some examples, the merge recovery component 420, or various components thereof, may be configured to perform various operations (e.g., receiving, monitoring, transmitting) using or otherwise in cooperation with the input interface 410, the output interface 415, or both. For example, the merge recovery component 420 may receive information from the input interface 410, send information to the output interface 415, or be integrated in combination with the input interface 410, the output interface 415, or both to receive information, transmit information, or perform various other operations as described herein.

The recovery request component 425 may be configured as or otherwise support a means for receiving, at a data management system, a first request to recover one or more attributes associated with one or more directory objects within a directory of a client system, where the first request indicates the one or more attributes and a first time corresponding to a prior backup of the one or more attributes. The merge preview component 430 may be configured as or otherwise support a means for outputting, via a user interface of the data management system, a representation of a merged state of the one or more attributes, where the merged state is based on a merge between a first state of the one or more attributes as of the first time indicated via the first request and a live state of the one or more attributes as of a second time at which the merge is performed. The recovery request component 425 may be configured as or otherwise support a means for receiving, in response to outputting the representation of the merged state of the one or more attributes and via the user interface of the data management system, a second request that indicates whether the data management system is to recover the one or more attributes in accordance with the merged state.

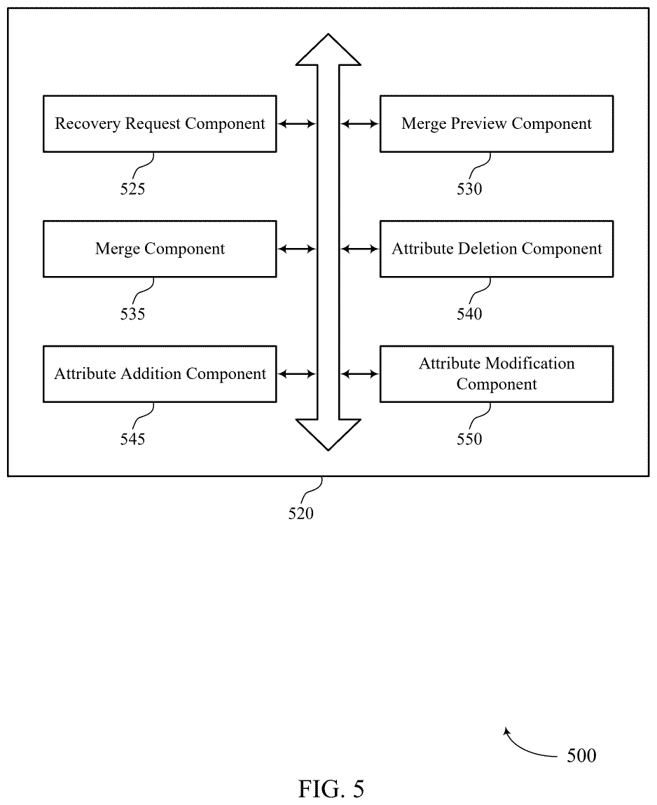

FIG. 5 shows a block diagram 500 of a merge recovery component 520 that supports preview for merge operation in recovery in accordance with aspects of the present disclosure. The merge recovery component 520 may be an example of aspects of a merge recovery component or a merge recovery component 420, or both, as described herein. The merge recovery component 520, or various components thereof, may be an example of means for performing various aspects of preview for merge operation in recovery as described herein. For example, the merge recovery component 520 may include a recovery request component 525, a merge preview component 530, a merge component 535, an attribute deletion component 540, an attribute addition component 545, an attribute modification component 550, or any combination thereof. Each of these components, or components of subcomponents thereof (e.g., one or more processors, one or more memories), may communicate, directly or indirectly, with one another (e.g., via one or more buses, communications links, communications interfaces, or any combination thereof).

The recovery request component 525 may be configured as or otherwise support a means for receiving, at a data management system, a first request to recover one or more attributes associated with one or more directory objects within a directory of a client system, wherein the first request indicates the one or more attributes and a first time corresponding to a prior backup of the one or more attributes. The merge preview component 530 may be configured as or otherwise support a means for outputting, via a user interface of the data management system, a representation of a merged state of the one or more attributes, wherein the merged state is based at least in part on a merge between a first state of the one or more attributes as of the first time indicated via the first request and a live state of the one or more attributes as of a second time at which the merge is performed. In some examples, the recovery request component 525 may be configured as or otherwise support a means for receiving, in response to outputting the representation of the merged state of the one or more attributes and via the user interface of the data management system, a second request that indicates whether the data management system is to recover the one or more attributes in accordance with the merged state.

In some examples, the merge component 535 may be configured as or otherwise support a means for erasing the live state of the one or more attributes from the directory based at least in part on the second request indicating that the data management system is to recover the one or more attributes to the merged state. In some examples, the merge component 535 may be configured as or otherwise support a means for writing, to the directory based on the second request, the merged state of the one or more attributes.

In some examples, the recovery request component 525 may be configured as or otherwise support a means for maintaining the live state of the one or more attributes in the directory after performing the merge based on the second request indicating that the data management system is to refrain from recovering the one or more attributes to the merged state.

In some examples, the recovery request component 525 may be configured as or otherwise support a means for receiving, after the second request, a third request to recover the one or more attributes to a third time corresponding to a second prior backup of the one or more attributes.

In some examples, a first attribute is deleted from the directory between the first time and the second time, the directory including a directory of active computing objects authorized within the client system. In some examples, the one or more attributes include the first attribute at the first time indicated via the first request. In some examples, the representation of the merged state of the one or more attributes excludes the first attribute based on the first attribute being deleted from the directory before the second time at which the merge is performed.

In some examples, the attribute deletion component 540 may be configured as or otherwise support a means for outputting, via the user interface in response to the first request, an indication that the first attribute was deleted from the directory before the second time and is excluded from the merged state of the one or more attributes.

In some examples, the first request indicates a directory group including the one or more attributes at the first time, and the attribute deletion component 540 may be configured as or otherwise support a means for removing, between the first time and the second time, a first attribute from the directory group indicated via the first request, where a third state of the one or more attributes included in the directory group as of the second time at which the merge is performed may exclude the first attribute based on the removing, and where the representation of the merged state of the one or more attributes may include the first attribute based on the first attribute being included in the directory group as of the first time indicated via the first request and further based on the first attribute remaining in the directory at the second time, the directory including a directory of active directory objects authorized within the client system.

In some examples, the first request indicates a directory group including the one or more attributes at the first time, and the attribute addition component 545 may be configured as or otherwise support a means for adding, between the first time and the second time, a first attribute to the directory group, where the first state of the one or more attributes included in the directory group as of the first time indicated via the first request may exclude the first attribute based on the first attribute being added to the directory group after the first time, and where the representation of the merged state of the one or more attributes may include the first attribute.

In some examples, to support outputting the representation of the merged state of the one or more attributes, the merge preview component 530 may be configured as or otherwise support a means for outputting, via the user interface of the data management system and in response to the first request, a representation of the first state of the one or more attributes and the representation of the merged state of the one or more co attributes, where the second request is based on a comparison of the first state and the merged state.

In some examples, the merge preview component 530 may be configured as or otherwise support a means for outputting, via the user interface of the data management system and before completing the merge, a representation of the first state of the one or more attributes, a merge processing indication, and an option for direct recovery of the one or more attributes to the first state as of the first time, where the representation of the merged state of the one or more attributes replaces the merge processing indication within the user interface after the merge is complete.

In some examples, the first request indicates a type of recovery for recovering the one or more attributes, the type of recovery including one of a merge recovery type or a direct recovery type. In some examples, outputting the representation of the merged state of the one or more attributes is based on the first request indicating the merge recovery type.

In some examples, the one or more attributes are associated with one or more users, one or more tenants, one or more resources, one or more elements, one or more files, or any combination thereof.

In some examples, the one or more attributes include one or more linked attributes that are linked to one or more second directory objects.

FIG. 6 shows a block diagram 600 of a system 605 that supports preview for merge operation in recovery in accordance with aspects of the present disclosure. The system 605 may be an example of or include components of a system 405 as described herein. The system 605 may include components for data management, including components such as a merge recovery component 620, an input information 610, an output information 615, a network interface 625, at least one memory 630, at least one processor 635, and a storage 640. These components may be in electronic communication or otherwise coupled with each other (e.g., operatively, communicatively, functionally, electronically, electrically; via one or more buses, communications links, communications interfaces, or any combination thereof). Additionally, the components of the system 605 may include corresponding physical components or may be implemented as corresponding virtual components (e.g., components of one or more virtual machines). In some examples, the system 605 may be an example of aspects of one or more components described with reference to FIG. 1, such as a DMS 110.

The network interface 625 may enable the system 605 to exchange information (e.g., input information 610, output information 615, or both) with other systems or devices (not shown). For example, the network interface 625 may enable the system 605 to connect to a network (e.g., a network 120 as described herein). The network interface 625 may include one or more wireless network interfaces, one or more wired network interfaces, or any combination thereof. In some examples, the network interface 625 may be an example of may be an example of aspects of one or more components described with reference to FIG. 1, such as one or more network interfaces 165.

Memory 630 may include RAM, ROM, or both. The memory 630 may store computer-readable, computer-executable software including instructions that, when executed, cause the processor 635 to perform various functions described herein. In some cases, the memory 630 may contain, among other things, a basic input/output system (BIOS), which may control basic hardware or software operation such as the interaction with peripheral components or devices. In some cases, the memory 630 may be an example of aspects of one or more components described with reference to FIG. 1, such as one or more memories 175.

The processor 635 may include an intelligent hardware device, (e.g., a general-purpose processor, a DSP, a CPU, a microcontroller, an ASIC, a field programmable gate array (FPGA), a programmable logic device, a discrete gate or transistor logic component, a discrete hardware component, or any combination thereof). The processor 635 may be configured to execute computer-readable instructions stored in a memory 630 to perform various functions (e.g., functions or tasks supporting preview for merge operation in recovery). Though a single processor 635 is depicted in the example of FIG. 6, it is to be understood that the system 605 may include any quantity of one or more of processors 635 and that a group of processors 635 may collectively perform one or more functions ascribed herein to a processor, such as the processor 635. In some cases, the processor 635 may be an example of aspects of one or more components described with reference to FIG. 1, such as one or more processors 170.

Storage 640 may be configured to store data that is generated, processed, stored, or otherwise used by the system 605. In some cases, the storage 640 may include one or more HDDs, one or more SDDs, or both. In some examples, the storage 640 may be an example of a single database, a distributed database, multiple distributed databases, a data store, a data lake, or an emergency backup database. In some examples, the storage 640 may be an example of one or more components described with reference to FIG. 1, such as one or more network disks 180.

For example, the merge recovery component 620 may be configured as or otherwise support a means for receiving, at a data management system, a first request to recover one or more computing objects of a set of multiple computing objects within a client system, where the first request indicates the one or more computing objects and a first time corresponding to a prior backup of the one or more computing objects. The merge recovery component 620 may be configured as or otherwise support a means for outputting, via a user interface of the data management system, a representation of a merged state of the one or more computing objects, where the merged state is based on a merge between a first state of the one or more computing objects as of the first time indicated via the first request and a live state of the one or more computing objects as of a second time at which the merge is performed. The merge recovery component 620 may be configured as or otherwise support a means for receiving, in response to outputting the representation of the merged state of the one or more computing objects and via the user interface of the data management system, a second request that indicates whether the data management system is to recover the one or more computing objects in accordance with the merged state.

By including or configuring the merge recovery component 620 in accordance with examples as described herein, the system 605 may support techniques for preview for merge operation in recovery, which may provide one or more benefits such as, for example, improved reliability, improved user experience, more efficient utilization of computing resources, network resources or both, and improved security, among other possibilities.

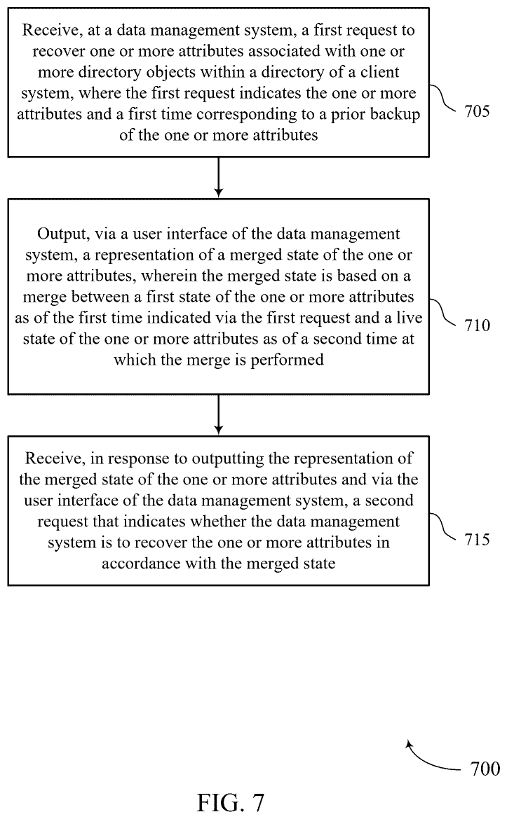

FIG. 7 shows a flowchart illustrating a method 700 that supports preview for merge operation in recovery in accordance with aspects of the present disclosure. The operations of the method 700 may be implemented by a DMS or its components as described herein. For example, the operations of the method 700 may be performed by a DMS as described with reference to FIGS. 1 through 6. In some examples, a DMS may execute a set of instructions to control the functional elements of the DMS to perform the described functions. Additionally, or alternatively, the DMS may perform aspects of the described functions using special-purpose hardware.

At 705, the method may include receiving, at a data management system, a first request to recover one or more attributes associated with one or more directory objects within a directory of a client system, where the first request indicates the one or more attributes and a first time corresponding to a prior backup of the one or more attributes. The operations of 705 may be performed in accordance with examples as disclosed herein. In some examples, aspects of the operations of 705 may be performed by a recovery request component 525 as described with reference to FIG. 5.

At 710, the method may include outputting, via a user interface of the data management system, a representation of a merged state of the one or more attributes, wherein the merged state is based on a merge between a first state of the one or more attributes as of the first time indicated via the first request and a live state of the one or more attributes as of a second time at which the merge is performed. The operations of 710 may be performed in accordance with examples as disclosed herein. In some examples, aspects of the operations of 710 may be performed by a merge preview component 530 as described with reference to FIG. 5.

At 715, the method may include receiving, in response to outputting the representation of the merged state of the one or more attributes and via the user interface of the data management system, a second request that indicates whether the data management system is to recover the one or more attributes in accordance with the merged state. The operations of 715 may be performed in accordance with examples as disclosed herein. In some examples, aspects of the operations of 715 may be performed by a recovery request component 525 as described with reference to FIG. 5.

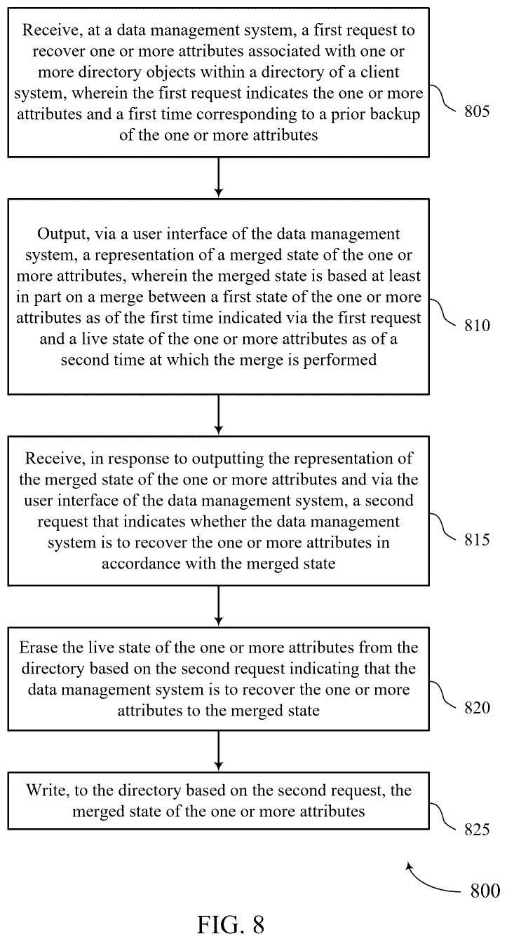

FIG. 8 shows a flowchart illustrating a method 800 that supports preview for merge operation in recovery in accordance with aspects of the present disclosure. The operations of the method 800 may be implemented by a DMS or its components as described herein. For example, the operations of the method 800 may be performed by a DMS as described with reference to FIGS. 1 through 6. In some examples, a DMS may execute a set of instructions to control the functional elements of the DMS to perform the described functions. Additionally, or alternatively, the DMS may perform aspects of the described functions using special-purpose hardware.

At 805, the method may include receiving, at a data management system, a first request to recover one or more attributes associated with one or more directory objects within a directory of a client system, where the first request indicates the one or more attributes and a first time corresponding to a prior backup of the one or more attributes. The operations of 805 may be performed in accordance with examples as disclosed herein. In some examples, aspects of the operations of 805 may be performed by a recovery request component 525 as described with reference to FIG. 5.

At 810, the method may include outputting, via a user interface of the data management system, a representation of a merged state of the one or more attributes, wherein the merged state is based on a merge between a first state of the one or more attributes as of the first time indicated via the first request and a live state of the one or more attributes as of a second time at which the merge is performed. The operations of 810 may be performed in accordance with examples as disclosed herein. In some examples, aspects of the operations of 810 may be performed by a merge preview component 530 as described with reference to FIG. 5.

At 815, the method may include receiving, in response to outputting the representation of the merged state of the one or more attributes and via the user interface of the data management system, a second request that indicates whether the data management system is to recover the one or more attributes in accordance with the merged state. The operations of 815 may be performed in accordance with examples as disclosed herein. In some examples, aspects of the operations of 815 may be performed by a recovery request component 525 as described with reference to FIG. 5.

At 820, the method may include erasing the live state of the one or more computing objects from the client system based on the second request indicating that the data management system is to recover the one or more computing objects to the merged state. The operations of 820 may be performed in accordance with examples as disclosed herein. In some examples, aspects of the operations of 820 may be performed by a merge component 535 as described with reference to FIG. 5.

At 825, the method may include writing, to the directory based on the second request, the merged state of the one or more attributes. The operations of 825 may be performed in accordance with examples as disclosed herein. In some examples, aspects of the operations of 825 may be performed by a merge component 535 as described with reference to FIG. 5.

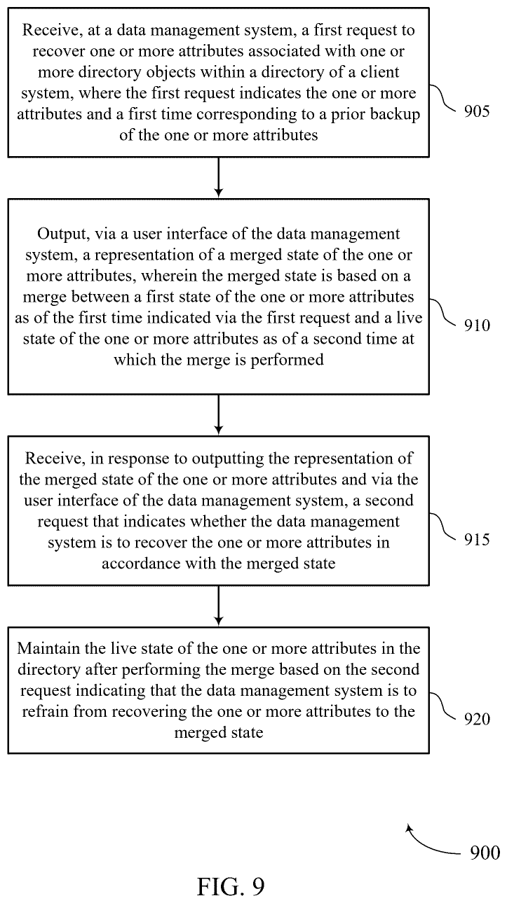

FIG. 9 shows a flowchart illustrating a method 900 that supports preview for merge operation in recovery in accordance with aspects of the present disclosure. The operations of the method 900 may be implemented by a DMS or its components as described herein. For example, the operations of the method 900 may be performed by a DMS as described with reference to FIGS. 1 through 6. In some examples, a DMS may execute a set of instructions to control the functional elements of the DMS to perform the described functions. Additionally, or alternatively, the DMS may perform aspects of the described functions using special-purpose hardware.

At 905, the method may include receiving, at a data management system, a first request to recover one or more attributes associated with one or more directory objects within a directory of a client system, where the first request indicates the one or more attributes and a first time corresponding to a prior backup of the one or more attributes. The operations of 905 may be performed in accordance with examples as disclosed herein. In some examples, aspects of the operations of 905 may be performed by a recovery request component 525 as described with reference to FIG. 5.

At 910, the method may include outputting, via a user interface of the data management system, a representation of a merged state of the one or more attributes, wherein the merged state is based on a merge between a first state of the one or more attributes as of the first time indicated via the first request and a live state of the one or more attributes as of a second time at which the merge is performed. The operations of 910 may be performed in accordance with examples as disclosed herein. In some examples, aspects of the operations of 910 may be performed by a merge preview component 530 as described with reference to FIG. 5.

At 915, the method may include receiving, in response to outputting the representation of the merged state of the one or more attributes and via the user interface of the data management system, a second request that indicates whether the data management system is to recover the one or more attributes in accordance with the merged state. The operations of 915 may be performed in accordance with examples as disclosed herein. In some examples, aspects of the operations of 915 may be performed by a recovery request component 525 as described with reference to FIG. 5.

At 920, the method may include maintaining the live state of the one or more attributes in the directory after performing the merge based on the second request indicating that the data management system is to refrain from recovering the one or more attributes to the merged state. The operations of 920 may be performed in accordance with examples as disclosed herein. In some examples, aspects of the operations of 920 may be performed by a recovery request component 525 as described with reference to FIG. 5.

The following provides an overview of aspects of the present disclosure:

Aspect 1: A method, comprising: receiving, at a data management system, a first request to recover one or more attributes associated with one or more directory objects within a directory of a client system, wherein the first request indicates the one or more attributes and a first time corresponding to a prior backup of the one or more attributes; outputting, via a user interface of the data management system, a representation of a merged state of the one or more attributes, wherein the merged state is based at least in part on a merge between a first state of the one or more attributes as of the first time indicated via the first request and a live state of the one or more attributes as of a second time at which the merge is performed; and receiving, in response to outputting the representation of the merged state of the one or more attributes and via the user interface of the data management system, a second request that indicates whether the data management system is to recover the one or more attributes in accordance with the merged state.

Aspect 2: The method of aspect 1, further comprising: erasing the live state of the one or more attributes from the directory based at least in part on the second request indicating that the data management system is to recover the one or more attributes to the merged state; and writing, to the directory based at least in part on the second request, the merged state of the one or more attributes.

Aspect 3: The method of aspect 1, further comprising: maintaining the live state of the one or more attributes in the directory after performing the merge based at least in part on the second request indicating that the data management system is to refrain from recovering the one or more attributes to the merged state.

Aspect 4: The method of aspect 3, further comprising: receiving, after the second request, a third request to recover the one or more attributes to a third time corresponding to a second prior backup of the one or more attributes.

Aspect 5: The method of any of aspects 1 through 4, wherein a first attribute is deleted from the directory between the first time and the second time, the directory comprising active directory objects authorized within the client system, the one or more attributes comprise the first attribute at the first time indicated via the first request, and the representation of the merged state of the one or more attributes excludes the first attribute based at least in part on the first attribute being deleted from the directory before the second time at which the merge is performed.

Aspect 6: The method of aspect 5, further comprising: outputting, via the user interface in response to the first request, an indication that the first attribute was deleted from the directory before the second time and is excluded from the merged state of the one or more attributes.

Aspect 7: The method of any of aspects 1 through 6, wherein the first request indicates a directory group comprising the one or more attributes at the first time, the method further comprising: removing, between the first time and the second time, a first attribute from the directory group indicated via the first request, wherein: a third state of the one or more attributes included in the directory group as of the second time at which the merge is performed excludes the first attribute based at least in part on the removing, and the representation of the merged state of the one or more attributes includes the first attribute based at least in part on the first attribute being included in the directory group as of the first time indicated via the first request and further based at least in part on the first attribute remaining in the directory at the second time, the directory comprising active directory objects authorized within the client system.

Aspect 8: The method of any of aspects 1 through 6, wherein the first request indicates a directory group comprising the one or more attributes at the first time, the method further comprising: adding, between the first time and the second time, a first attribute to the directory group, wherein: the first state of the one or more attributes included in the directory group as of the first time indicated via the first request excludes the first attribute based at least in part on the first attribute being added to the directory group after the first time, and the representation of the merged state of the one or more attributes includes the first attribute.

Aspect 9: The method of any of aspects 1 through 8, wherein outputting the representation of the merged state of the one or more attributes comprises: outputting, via the user interface of the data management system and in response to the first request, a representation of the first state of the one or more attributes and the representation of the merged state of the one or more attributes, wherein the second request is based at least in part on a comparison of the first state and the merged state.

Aspect 10: The method of aspect 9, further comprising: outputting, via the user interface of the data management system and before completing the merge, a representation of the first state of the one or more attributes, a merge processing indication, and an option for direct recovery of the one or more attributes to the first state as of the first time, wherein the representation of the merged state of the one or more attributes replaces the merge processing indication within the user interface after the merge is complete.

Aspect 11: The method of any of aspects 1 through 10, wherein the first request indicates a type of recovery for recovering the one or more attributes, the type of recovery comprising one of a merge recovery type or a direct recovery type, and outputting the representation of the merged state of the one or more attributes is based at least in part on the first request indicating the merge recovery type.

Aspect 12: The method of any of aspects 1 through 11, wherein the one or more attributes are associated with one or more users, one or more tenants, one or more resources, one or more elements, one or more files, or any combination thereof.

Aspect 13: The method of any of aspects 1 through 12, wherein the one or more attributes comprise one or more linked attributes that are linked to one or more second directory objects.

Aspect 14: An apparatus comprising one or more memories storing processor-executable code, and one or more processors coupled with the one or more memories and individually or collectively operable to execute the code to cause the apparatus to perform a method of any of aspects 1 through 13.

Aspect 15: An apparatus comprising at least one means for performing a method of any of aspects 1 through 13.

Aspect 16: A non-transitory computer-readable medium storing code the code comprising instructions executable by one or more processors to perform a method of any of aspects 1 through 13.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Further, a system as used herein may be a collection of devices, a single device, or aspects within a single device.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, EEPROM) compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, “a component” having characteristics or performing functions may refer to “at least one of one or more components” having a particular characteristic or performing a particular function. Subsequent reference to a component introduced with the article “a” using the terms “the” or “said” refers to any or all of the one or more components. For example, a component introduced with the article “a” shall be understood to mean “one or more components,” and referring to “the component” subsequently in the claims shall be understood to be equivalent to referring to “at least one of the one or more components.”

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus, comprising:
one or more memories storing processor-executable code; and
one or more processors coupled with the one or more memories and individually or collectively operable to execute the code to cause the apparatus to:
receive, at a data management system, a first request to recover one or more attributes associated with one or more directory objects within a directory of a client system, wherein the first request indicates the one or more attributes and a first time corresponding to a prior backup of the one or more attributes;
output, via a user interface of the data management system, a representation of a merged state of the one or more attributes, wherein the merged state is based at least in part on a merge between a first state of the one or more attributes as of the first time indicated via the first request and a live state of the one or more attributes as of a second time at which the merge is performed; and
receive, in response to outputting the representation of the merged state of the one or more attributes and via the user interface of the data management system, a second request that indicates whether the data management system is to recover the one or more attributes in accordance with the merged state.

2. The apparatus of claim 1, wherein the one or more processors are individually or collectively further operable to execute the code to cause the apparatus to:
erase the live state of the one or more attributes from the directory based at least in part on the second request indicating that the data management system is to recover the one or more attributes to the merged state; and
write, to the directory based at least in part on the second request, the merged state of the one or more attributes.

3. The apparatus of claim 1, wherein the one or more processors are individually or collectively further operable to execute the code to cause the apparatus to:
maintain the live state of the one or more attributes in the directory after performing the merge based at least in part on the second request indicating that the data management system is to refrain from recovering the one or more attributes to the merged state.

4. The apparatus of claim 3, wherein the one or more processors are individually or collectively further operable to execute the code to cause the apparatus to:
receive, after the second request, a third request to recover the one or more attributes to a third time corresponding to a second prior backup of the one or more attributes.

5. The apparatus of claim 1, wherein:
a first attribute is deleted from the directory between the first time and the second time, the directory comprising active directory objects authorized within the client system,
the one or more attributes comprise the first attribute at the first time indicated via the first request, and
the representation of the merged state of the one or more attributes excludes the first attribute based at least in part on the first attribute being deleted from the directory before the second time at which the merge is performed.

6. The apparatus of claim 5, wherein the one or more processors are individually or collectively further operable to execute the code to cause the apparatus to:
output, via the user interface in response to the first request, an indication that the first attribute was deleted from the directory before the second time and is excluded from the merged state of the one or more attributes.

7. The apparatus of claim 1, wherein the first request indicates a directory group comprising the one or more attributes at the first time, and wherein the one or more processors are individually or collectively further operable to execute the code to cause the apparatus to:
remove, between the first time and the second time, a first attribute from the directory group indicated via the first request, wherein:
a third state of the one or more attributes included in the directory group as of the second time at which the merge is performed excludes the first attribute based at least in part on the removing, and
the representation of the merged state of the one or more attributes includes the first attribute based at least in part on the first attribute being included in the directory group as of the first time indicated via the first request and further based at least in part on the first attribute remaining in the directory at the second time, the directory comprising active directory objects authorized within the client system.

8. The apparatus of claim 1, wherein the first request indicates a directory group comprising the one or more attributes at the first time, and wherein the one or more processors are individually or collectively further operable to execute the code to cause the apparatus to:
add, between the first time and the second time, a first attribute to the directory group, wherein:
the first state of the one or more attributes included in the directory group as of the first time indicated via the first request excludes the first attribute based at least in part on the first attribute being added to the directory group after the first time, and
the representation of the merged state of the one or more attributes includes the first attribute.

9. The apparatus of claim 1, wherein, to output the representation of the merged state of the one or more attributes, the one or more processors are individually or collectively operable to execute the code to cause the apparatus to:
output, via the user interface of the data management system and in response to the first request, a representation of the first state of the one or more attributes and the representation of the merged state of the one or more attributes, wherein the second request is based at least in part on a comparison of the first state and the merged state.

10. The apparatus of claim 9, wherein the one or more processors are individually or collectively further operable to execute the code to cause the apparatus to:
output, via the user interface of the data management system and before completing the merge, a representation of the first state of the one or more attributes, a merge processing indication, and an option for direct recovery of the one or more attributes to the first state as of the first time, wherein the representation of the merged state of the one or more attributes replaces the merge processing indication within the user interface after the merge is complete.

11. The apparatus of claim 1, wherein:
the first request indicates a type of recovery for recovering the one or more attributes, the type of recovery comprising one of a merge recovery type or a direct recovery type, and
the one or more processors are individually or collectively operable to execute the code to cause the apparatus to output the representation of the merged state of the one or more attributes based at least in part on the first request indicating the merge recovery type.

12. The apparatus of claim 1, wherein the one or more attributes are associated with one or more users, one or more tenants, one or more resources, one or more elements, one or more files, or any combination thereof.

13. The apparatus of claim 1, wherein the one or more attributes comprise one or more linked attributes that are linked to one or more second directory objects.

14. A method, comprising:
receiving, at a data management system, a first request to recover one or more attributes associated with one or more directory objects within a directory of a client system, wherein the first request indicates the one or more attributes and a first time corresponding to a prior backup of the one or more attributes;
outputting, via a user interface of the data management system, a representation of a merged state of the one or more attributes, wherein the merged state is based at least in part on a merge between a first state of the one or more attributes as of the first time indicated via the first request and a live state of the one or more attributes as of a second time at which the merge is performed; and
receiving, in response to outputting the representation of the merged state of the one or more attributes and via the user interface of the data management system, a second request that indicates whether the data management system is to recover the one or more attributes in accordance with the merged state.

15. The method of claim 14, further comprising:
erasing the live state of the one or more attributes from the directory based at least in part on the second request indicating that the data management system is to recover the one or more attributes to the merged state; and
writing, to the directory based at least in part on the second request, the merged state of the one or more attributes.

16. The method of claim 14, further comprising:
maintaining the live state of the one or more attributes in the directory after performing the merge based at least in part on the second request indicating that the data management system is to refrain from recovering the one or more attributes to the merged state.

17. The method of claim 16, further comprising:
receiving, after the second request, a third request to recover the one or more attributes to a third time corresponding to a second prior backup of the one or more attributes.

18. The method of claim 14, wherein:
a first attribute is deleted from the directory between the first time and the second time, the directory comprising active directory objects authorized within the client system,
the one or more attributes comprise the first attribute at the first time indicated via the first request, and
the representation of the merged state of the one or more attributes excludes the first attribute based at least in part on the first attribute being deleted from the directory before the second time at which the merge is performed.

19. The method of claim 18, further comprising:
outputting, via the user interface in response to the first request, an indication that the first attribute was deleted from the directory before the second time and is excluded from the merged state of the one or more attributes.

20. A non-transitory computer-readable medium storing code, the code comprising instructions executable by one or more processors to:
receive, at a data management system, a first request to recover one or more attributes associated with one or more directory objects within a directory of a client system, wherein the first request indicates the one or more attributes and a first time corresponding to a prior backup of the one or more attributes;
output, via a user interface of the data management system, a representation of a merged state of the one or more attributes, wherein the merged state is based at least in part on a merge between a first state of the one or more attributes as of the first time indicated via the first request and a live state of the one or more attributes as of a second time at which the merge is performed; and
receive, in response to outputting the representation of the merged state of the one or more attributes and via the user interface of the data management system, a second request that indicates whether the data management system is to recover the one or more attributes in accordance with the merged state.
